(19) United States
(12) Patent Application Publication
(10) Pub. No.: US 2009/0309403 A1
(43) Pub. Date: Dec. 17, 2009

(54) CATCH FITTING

(75) Inventor: Michael Mackert, Ruthen (DE)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Kintec-Solution GmbH, Geseke (DE)

(21) Appl. No.: 11/996,198

(22) PCT Filed: Jul. 7, 2006
(86) PCT No.: PCT/EP06/64010

§ 371 Date: Jun. 9, 2008

(30) Foreign Application Priority Data
Jul. 20, 2005 (DE) 20 2005 011386.7

(51) Int. Cl. A47C 1/025; B60N 2/235

(52) U.S. Cl. 297/354.13

(57) ABSTRACT

The invention relates to a catch fitting (1) of an adjustable back rest or support of a piece of furniture, especially a piece of furniture for sitting or lying down. Said fitting comprises a connection plate (2) and a stop notch plate (3) that is pivotably connected to the connection plate and can be locked in various angular positions. Said stop not plate comprises a toothing (8) which is concentrically arranged in relation to the axis (6) of the articulation, a locking device (4) which is rotably mounted on the connection plate (2) engaging with said toothing in the catch position. Said locking device (4) is held by a spring (5) in the released position and is acted upon by the same spring (5) in the engaged position. The aim of the invention is to keep the structural dimensions to a minimum, while ensuring a high holding force and an engagement adjustment region which is as large as possible. To this end, an abutment cam (10) is simply provided on the stop notch plate (3) for releasing the locking device (4) by co-operation with a release lug (12), and the locking device (4) is provided with an engaging surface (11) which co-operates with the toothing (8) for the engagement.

The present invention concerns a catch fitting of an adjustable back rest or support of a piece of furniture, especially a piece of furniture for sitting or lying down, with a connection plate and a stop notch plate that is pivotably connected to the connection plate and can be locked in various angular positions, having a toothing which is concentrically arranged in relation to the axis of the articulation, engaging with a locking device in the catch position, which is rotatably mounted on the connection plate, while the locking device is held by a spring in the released position and is acted upon by the same spring in the engaged position.

Such catch fittings are generally arranged in the side region of furniture, especially furniture for sitting or lying down, where they take up the least possible space so that they are inconspicuous.

What is more, the catch fittings need to have substantial holding force. Thus, the Landesgewerbeanstalt (LGA—State Business Office) requires a secure function of catch fittings as of a holding force of 180 Nm. Therefore, due to the stresses which occur, the catch teeth and the outer toothing of the catch fittings as well as the locking device need to be of dimensions and configuration such that corresponding holding forces are achieved.

In addition, the catch fittings should have a number of engaged positions, and so the toothing must have a corresponding number of teeth.

In particular, problems occur in the use of conventional catch fittings for slender, narrow pieces of furniture with a metal support or frame, such as furniture for sitting or lying down.

Thus, a catch fitting is known from DE 91 05 323 U1, in which the outer toothing is arranged between an abutment cam on the one side and a pressing lug on the other side, so that the entire active region which can interact with the locking device is bounded by the abutment cam on the one side and a pressing lug on the other side. In this catch fitting, the pressing lug on the one side and the abutment cam on the other side protrude outward at the side, so that the catch fitting has a relatively large structural size in the region of the articulation itself.

A catch fitting is known from DE 20 2005 003 960 U1, in which the pressing lug is arranged between the abutment cam and the outer toothing, so that it no longer protrudes outwardly and the stop notch plate as a whole can be kept more narrow in the region of the outer toothing. However, due to the geometry employed, this catch fitting still has a relatively large structural size. Moreover, the size of the region of the toothing is made smaller by the arrangement of the pressing lug, so that the corresponding locking pivot region is made smaller, because the number of teeth is reduced.

The problem of the invention is to provide a catch fitting whose structural size is as small as possible. In addition, the catch fitting should also have a large holding force and at the same time the largest possible engagement adjustment region. In particular, the catch fitting should furthermore be so small in structure that its installation in sitting or lying furniture is problem-free.

This problem is solved by the catch fitting reflected in claim 1.

Due to the fact that only one abutment cam is provided on the stop notch plate to release the locking device by cooperation with a release lug, and the locking device has an engaging surface that cooperates with the toothing for the engagement, it is possible to do away with the customary pressing lug for the engagement. Thus, its function is taken over by the toothing itself. In this way, the number of teeth is not decreased. Quite to the contrary, it is possible to design the toothed region especially large. Moreover, the distance between the locking device and the stop notch plate can be reduced, since no pressing lug which projects beyond the toothing is present or needed.

During its movement in the released position of the locking device, the toothing comes into contact with the engaging surface on the locking device and forces this into the engaged position. In the engaged position, the toothing merely engages with the catch teeth of the locking device.

In one embodiment, the engaging surface can be formed eccentrically to the pivot axis of the locking device. Moreover, the engaging surface can be bounded on one side by at least one catch tooth and on the other side by a release lug.

The “active” region of the actual engaging surface can be formed on the side of the release lug facing the toothing.

The spring of the catch fitting has a dual function. On the one hand, it holds the locking device in the engaged position in the catching with the toothing. On the other hand, the locking device holds it firm in the released position.

According to another embodiment of the catch fitting, the locking device has for this purpose a catch recess on the side away from the toothing, with which the spring engages when the locking device is in the released position and holds it fast. In addition, the locking device can have a bearing surface on the side away from the toothing, against which the spring lies in the engaged position of the locking device.

Preferably the catch recess and the bearing surface are arranged in proximity to each other, so that small movements of the locking device are already distinguished between the engaged and released position. This, in turn, allows a reduction in the overall structural size. The catch recess and the bearing surface can be separated by a sharp edge, so that a “snap action” results.

According to one preferred embodiment, the catch recess has a surface which is adapted to the shape and position of the front region of the spring, so that it lies sheetlike against or on top of the surface when the locking device is in the released state. Thus, despite the simple design of the locking device and the spring, a good and firm holding of the locking device by the spring is achieved.

An especially simple securement is achieved when the spring is held clamping against a cover, e.g., for the articulation region of the catch fitting.

According to one preferred embodiment, the locking device is sickle shaped. It is advantageous for the pivot axis of the locking device to be arranged asymmetrically, so that a favorable lever geometry is achieved.

One obtains an especially compact and, at the same time, simple catch fitting with high holding force when the pivot axis of the stop notch plate, the pivot axis of the locking device, and the longitudinal midlines of the two plates lie on the same line in the starting position of the catch fitting.

Additional features, details and benefits of the invention will emerge from the following description of a sample embodiment, using the drawing. This shows:

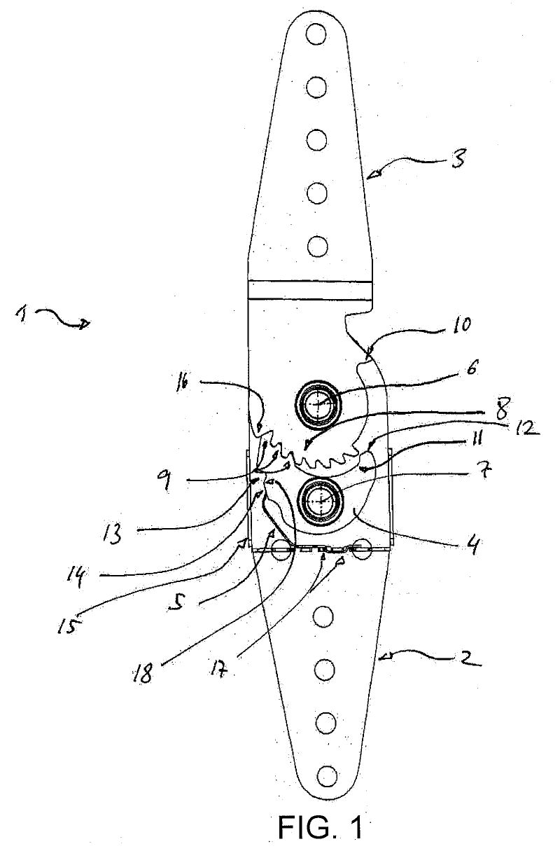

FIG. 1, a plan view of a catch fitting according to the invention in the engaged end position, the cover being cut open;

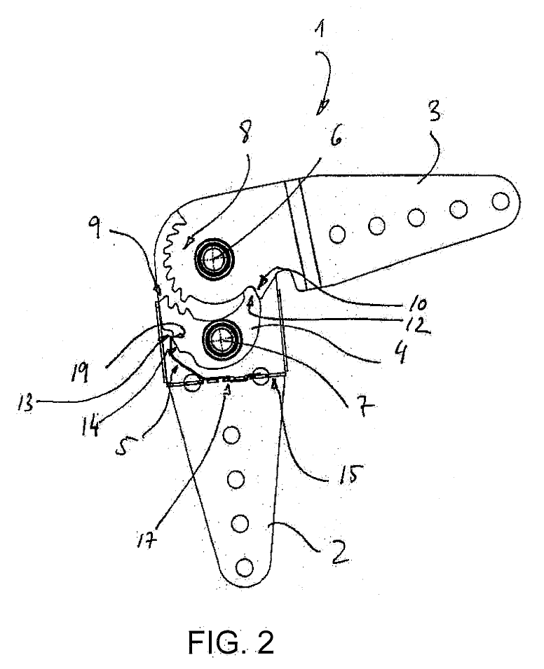

FIG. 2, the catch fitting of FIG. 1 in the released end position, and

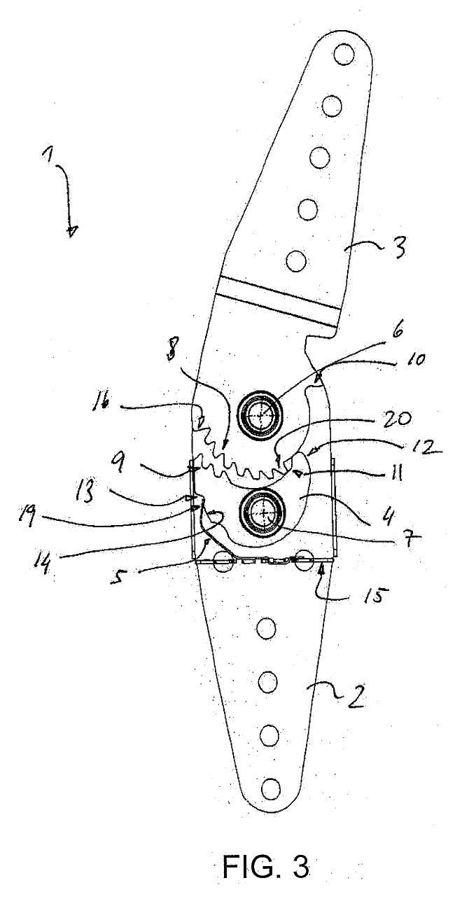

FIG. 3, the catch fitting from FIG. 1 in the position with the locking device engaged.

In FIGS. 1 to 3, a catch fitting designated as a whole by 1 is represented in plan view in various positions, the cover having been cut open and only its side walls 15 being indicated.

The catch fitting has a connection plate 2 for securing to the stationary part of a piece of furniture and a stop notch plate 3 for securing to the movable part of the furniture.

The connection plate 2 has two boreholes, not visible in the FIGS., in order to accommodate two rivets 6, 7 or the like, so as to secure the cover, on the one hand, and to form the respective pivot axes 6, 7 of the stop notch plate 3 and the locking device 4. These rivets 6, 7 can be provided with suitable sleeves or the like, in order to form the pivot axes.

The stop notch plate 3 has at one end a toothing 8 arranged concentrically to its pivot axis 6 or the axis of articulation of the catch fitting 1. On one side of the toothing 8 there is provided a stop 16 to limit the movement of the plates relative to each other. When the outer tooth of the locking device 4 lies against the stop 16 (see FIG. 1), the catch fitting is in the starting position. On the other side there is provided an abutment cam 10, separated or distanced by an untoothed region.

The locking device 4 is arranged opposite the toothing 8 and has a roughly sickle shape, being mounted eccentrically on the rivet 7 as a pivot axis. Several catch teeth 9 are arranged on one side and opposite the toothing 8, being configured so that they, together with the toothing 8, accomplish a self-locking and carry out the catching function. On the other side of the locking device 4 there is provided a release lug 12, separated or distanced by an untoothed region.

In the engaged position of the locking device 4 (see FIG. 1), three catch teeth 9 of the locking device 4 engage with the opposite-lying toothing 8 of the stop notch plate 3. A spring 5 is provided to maintain this engagement, acting upon the locking device 4 or holding it in the engaged position. For this, the spring 5 presses with its tip against a bearing surface 14 on the back side of the locking device 4. The spring 5 is a leaf spring and it is clamped in corresponding slots 17 of the side walls 15 of the cover.

The pivot axis 6 of the stop notch plate 3, the pivot axis 7 of the locking device 4 and the longitudinal midlines of the two plates 2, 3 lie on the same line in the starting position, as shown in FIG. 1.

To adjust the catch fitting 1, the stop notch plate 3 is turned clockwise relative to the connection plate 2.

If the stop notch plate 3 is turned so far in the clockwise direction relative to the connection plate 2 that the abutment cam 10 comes to bear against the release lug 12 and is further turned until it presses against this, the locking device 4 will be released against the force of the spring 5. This position is shown in FIG. 2.

When released, the position in which the spring 5 makes contact with the back side of the locking device 4 changes. In order to hold the locking device 4 in the released position, the spring 5 slides by its tip into a catch recess 13 next to the bearing surface 14 on the back side of the locking device. The transition between the catch recess 13 and the bearing surface 14 is formed by a sharp edge 18, so that the process involves a kind of “snap action”. This edge 18 passes into a somewhat flat surface 19 of the catch recess 13, which is adapted to the shape and position of the front region of the spring 5, so that this not only bears with its tip against the locking device 4, as is the case in the engaged state, but also lies with its front region in sheetlike manner against or on top of the surface 19. In this way, a good holding of the locking device by the spring and the dual functioning of the spring is achieved without having to specially machine the tip of the spring 5 or curve it in a costly manner.

To engage the locking device 4 once more, the stop notch plate 3 is turned back counterclockwise relative to the connection plate 2. In this process, the toothing 8 or its first tooth 20 comes into contact with the engaging surface 11. Thus, on the one hand, the engaging surface 11 is bounded by a catch tooth 9 and on the other hand by the release lug 12 or its back side.

The “active” region of the engaging surface 11, which is responsible for the actual engagement, is formed at the foot of the back side of the release lug 12 or on the side of the release lug 12 facing the toothing 8. This surface extends in the direction of the toothing 8 just far enough so that the toothing 8 moves past the engaging surface 11 or the back side of the release lug 12 without contact in the catching process, but the first tooth 20 of the toothing 20 in the changed position when the locking device 4 is in the released state comes to bear against it. The engaging surface 11 is formed eccentrically to the pivot axis 7 of the locking device 4, so that the tooth 20 is formed like all the other teeth and can be used in the catching process.

1. A catch fitting for an adjustable back rest or support of a piece of furniture, said catch fitting comprising:
a connection plate and a stop notch plate, said stop notch plate being pivotably connected to said connection plate and lockable in various angular positions, said stop notch plate having a toothing concentrically arranged in relation to a pivot axis of said stop notch plate, said toothing adapted to engage a locking device in an engaged position, said locking device being rotatably mounted on said connection plate, said locking device being held by a spring in a released position and acted upon by said spring in said engaged position, said stop notch plate including an abutment cam for releasing said locking device by cooperation with a release lug, and said locking device including an engaging surface that cooperates with said toothing for the engagement.

2. The catch fitting of claim 1, wherein the active region of said engaging surface is formed on the side of the said release lug facing said toothing.

3. The catch fitting of claim 2, wherein said engaging surface is formed eccentrically to a pivot axis of said locking device.

4. The catch fitting of claim 3, wherein said engaging surface of said locking device is bounded on one side by at least one catch tooth and on the other side by said release lug.

5. The catch fitting of claim 1, wherein said locking device has a catch recess on the side away from said toothing, and wherein said spring engages said catch recess when said locking device is in said released position whereby said locking device is held fast.

6. The catch fitting of claim 5, wherein said locking device has a bearing surface on the side away from said toothing, and wherein said spring lies against said bearing surface in said engaged position of said locking device.

7. The catch fitting of claim 6, wherein said catch recess and said bearing surface are separated by a sharp edge.

8. The catch fitting of claim 5, wherein said catch recess has a surface adapted to the shape and position of a front region of said spring whereby said spring lies sheetlike against or on top of said surface when said locking device is in the released state.

9. The catch fitting of claim 1, wherein said locking device has three catch teeth.

10. The catch fitting of claim 1, wherein said locking device is sickle shaped.

11. The catch fitting of claim 1, wherein said spring is held clamped by a cover.

12. The catch fitting of claim 1, wherein said pivot axis of said stop notch plate, a pivot axis of said locking device, and longitudinal midlines of said stop notch plate and said catch plates lie on the same line in a starting position of said catch fitting.

13. The catch fitting of claim 1, wherein said engaging surface is formed eccentrically to a pivot axis of said locking device.

14. The catch fitting of claim 1, wherein said locking device has a bearing surface on the side away from said toothing, and wherein said spring lies against said bearing surface in said engaged position of said locking device.

15. The catch fitting of claim 2, wherein said engaging surface of said locking device is bounded on one side by at least one catch tooth and on the other side by said release lug.

16. The catch fitting of claim 2, wherein said locking device has a catch recess on the side away from said toothing, and wherein said spring engages said catch recess when said locking device is in said released position whereby said locking device is held fast.

17. The catch fitting of claim 2, wherein said locking device has a bearing surface on the side away from said toothing, and wherein said spring lies against said bearing surface in said engaged position of said locking device.

18. The catch fitting of claim 4, wherein said locking device has three catch teeth.
